(19) United States
(12) Patent Application Publication
(10) Pub. No.: US 2011/0121223 A1
(43) Pub. Date: May 26, 2011

(54) MAGNETORHEOLOGICAL FLUIDS AND METHODS OF MAKING AND USING THE SAME

(75) Inventors: John C. Ulicny, Oxford, MI (US); Paul E. Krajewski, Troy, MI (US); Mark A. Golden, Washington, MI (US); Keith S. Snavely, Sterling Heights, MI (US)

(73) Assignee: GM GLOBAL TECHNOLOGY OPERATIONS, INC., Detroit, MI (US)

(21) Appl. No.: 12/623,913

(22) Filed: Nov. 23, 2009

(51) Int. Cl. C09K 3/00; H01F 1/26

(52) U.S. Cl. 252/62.52; 252/62.54

(57) ABSTRACT

One embodiment includes a magnetorheological fluid having an on-state yield stress when a magnetic field is applied thereto and comprising a carrier fluid and magnetizable particles suspended in the carrier fluid, and wherein the suspension of the magnetizable particles in the carrier fluid remains essentially homogenous indefinitely in the absence of the magnetic field, and wherein the on-state yield stress of the magnetorheological fluid is greater than or equal to that of poly(alpha)olefin fluid containing the same concentration of magnetizable particles, and wherein the off-state viscosity of the magnetorheological fluid is between about 0.4 and about 12 Pascal-seconds at 40° C.

### TECHNICAL FIELD

The field to which the disclosure generally relates includes magnetorheological (MR) fluids, and more specifically MR fluids with high on-state yield stress and low particle settling, and methods of making and using the same.

### BACKGROUND

Magnetorheological fluids undergo an increase in apparent viscosity in the presence of a magnetic field. Magnetorheological fluids generally include magnetizable particles dispersed or suspended in a carrier fluid. In the presence of a magnetic field, the magnetizable particles become polarized and organize into chains of particles or particle fibrils within the carrier fluid. The chains of particles or particle fibrils increase the apparent viscosity or flow resistance of the MR fluid, resulting in the development of a solid mass having a yield stress that must be exceeded to induce onset of flow of the MR fluid.

When the flow of the fluid composition is restricted as a result of orientation of the particles into chains, the fluid composition is said to be in its “on state.” The force required to exceed the yield stress is referred to as the “yield strength.” In the absence of a magnetic field, the particles return to a disorganized or free state and the apparent viscosity or flow resistance of the fluid composition is then correspondingly reduced. The state occupied by the composition in the absence of a magnetic field is referred to as the “off-state.”

Magnetorheological fluids may be used in devices or systems for controlling vibration and/or noise. For example, magnetorheological fluids are utilized to provide controllable forces that can act upon a piston in linear devices such as dampers or mounts. In these applications, the magnetorheological fluid can be subjected to shear forces greater than or equal to about 70 kilo Pascals (kPa), at shear rates of about 1,000 to about 50,000 sec⁻¹. MR fluids are useful in a variety of mechanical applications including, but not limited to, shock absorbers, controllable suspension systems, vibration dampeners, motor mounts, and electronically controllable force/torque transfer devices.

The magnetizable particles in MR fluid may settle to some extent due to gravity and possibly due to inertial effects in, for example, a clutch device in which the MR fluid may be used. The particle settling phenomenon may be quite problematic for MR fluids in certain applications. Some devices employing MR fluids may not function properly if the magnetizable particles are not well dispersed throughout the MR fluid.

### SUMMARY OF EXEMPLARY EMBODIMENTS OF THE INVENTION

One embodiment of the invention includes a magnetorheological fluid having an on-state yield stress when a magnetic field is applied thereto and comprising a carrier fluid and magnetizable particles suspended in the carrier fluid, and wherein the suspension of the magnetizable particles in the carrier fluid remains essentially homogenous indefinitely in the absence of the magnetic field, and wherein the on-state yield stress of the magnetorheological fluid is greater than or equal to that of poly(alpha)olefin (PAO) fluid containing the same concentration of magnetizable particles, and wherein the off-state viscosity of the magnetorheological fluid is between about 0.4 and about 12 Pascal-seconds at 40° C. By comparison, the off-state viscosity of the PAO fluid containing the same concentration of magnetizable particles is between about 0.2 and about 0.4 Pascal-seconds at 40° C.

Another embodiment of the invention includes a product comprising a tunable device comprising at least one chamber comprising magnetorheological fluid having an on-state yield stress when a magnetic field is applied thereto and wherein the magnetorheological fluid comprises a carrier fluid and magnetizable particles suspended in the carrier fluid, and wherein the suspension of the magnetizable particles in the carrier fluid remains essentially homogenous indefinitely in the absence of the magnetic field, and wherein the on-state yield stress of the magnetorheological fluid is greater than or equal to that of poly(alpha)olefin fluid containing the same concentration of magnetizable particles, and wherein the off-state viscosity of the magnetorheological fluid is between about 0.4 and about 12 Pascal-seconds at 40° C.

Another embodiment of the invention includes a method comprising applying a magnetic field to magnetorheological fluid to increase the yield-stress of the magnetorheological fluid such that its on-state yield stress is greater than or equal to that of poly(alpha)olefin fluid containing the same concentration of magnetizable particles, wherein the magnetorheological fluid comprises a carrier fluid and magnetizable particles suspended in the carrier fluid; and wherein the suspension of the magnetizable particles in the carrier fluid remains essentially homogenous indefinitely in the absence of the magnetic field; and wherein the off-state viscosity of the magnetorheological fluid is between about 0.4 and about 12 Pascal-seconds at 40° C.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a graph of on-state yield stress versus flux density for MR fluids comprising a grease carrier fluid according to one embodiment of the invention and conventional MR fluids.

FIG. 2 is a graph of viscosity versus shear rate for an MR fluid comprising PVA-water carrier fluid and 28 volume percent iron particles according to one embodiment of the invention.

FIG. 3 is a graph of storage modulus and loss modulus versus angular frequency for an MR fluid comprising PVA-water carrier fluid and 28 volume percent iron particles according to one embodiment of the invention.

FIG. 4 is a graph of damping factor versus angular frequency for an MR fluid comprising PVA-water carrier fluid and 28 volume percent iron particles according to one embodiment of the invention.

FIG. 5 is a graph of on-state yield stress versus flux density for an MR fluid comprising PVA-water carrier fluid and 28.3 volume percent iron particles and for an MR fluid comprising PVA-water carrier fluid and 12.4 volume percent iron particles according to embodiments of the invention.

FIG. 6 is a graph of viscosity and shear stress versus shear rate for a PVC paste carrier fluid comprising poly-vinyl chloride (PVC) and dioctyl phthalate (DOTP) in a 1:1 ratio by weight according to one embodiment of the invention.

FIG. 7 is a graph of viscosity and shear stress versus shear rate for a PVC paste carrier fluid comprising PVC and DOTP in a 9:4 ratio by weight according to one embodiment of the invention.

FIG. 8 is a graph of viscosity and shear stress versus shear rate for an MR fluid comprising a PVC paste carrier fluid comprising PVC and DOTP, and iron particles, where the PVC, DOTP and iron particles are in a 1:1:3 ratio by weight according to one embodiment of the invention.

FIG. 9 is a graph of on-state yield stress versus iron volume fraction for MR fluids comprising PVC paste carrier fluid and MR fluids comprising grease carrier fluid according to embodiments of the invention, and conventional MR fluids.

FIG. 10 is a graph of specific on-state yield stress versus iron volume fraction for MR fluids comprising PVC paste carrier fluid and MR fluids comprising grease carrier fluid according to embodiments of the invention, and conventional MR fluids.

FIG. 11 is a cross sectional view of an impact energy absorber containing an MR fluid according to one embodiment of the invention.

FIG. 12 is a cross sectional view of a clutch mechanism containing an MR fluid according to one embodiment of the invention.

### DETAILED DESCRIPTION OF EXEMPLARY EMBODIMENTS

The following description of the embodiment(s) is merely exemplary (illustrative) in nature and is in no way intended to limit the invention, its application, or uses.

One embodiment of the invention includes an MR fluid comprising magnetizable particles dispersed or suspended in a carrier fluid. In various embodiments, the carrier fluid may be at least one of gelatin carrier fluid, dough-like fluid carrier fluid, grease carrier fluid, PVA-water carrier fluid, PVC paste carrier fluid, silicone polymer carrier fluid, or cellulose polymer carrier fluid, as described below.

Embodiments of the MR fluid include magnetizable particles. The magnetizable particles are micron-sized, and may be in the form of metal powders. The magnetizable particles may have an average particle size of about 0.01 micrometer to about 500 micrometers. In another embodiment, the magnetizable particles may have an average particle size of about 0.01 micrometer to about 100 micrometers. In another embodiment, the magnetizable particles may have an average particle size of about 0.01 micrometer to about 50 micrometers. In another embodiment, the magnetizable particles may have an average particle size of about 0.01 micrometer to about 20 micrometers.

The magnetizable particles may be spherical in shape. However, it is also contemplated that the magnetizable particles may have irregular or nonspherical shapes as desired or required. Additionally, a particle distribution of nonspherical particles as disclosed herein may have some nearly spherical particles within its distribution. Where carbonyl iron powder is employed, for example, it is contemplated that a significant portion of the particles will have a spherical or near spherical shape.

In one embodiment, the magnetizable particles may be present in bimodal distributions of large particles and small particles. The composition of the large and small particle groups may be the same, similar, or different. The large particles may have an average particle size distribution between about 5 and about 30 micrometers. The small particles may have an average particle size distribution between about 0.5 and about 10 micrometers. In the bimodal distributions as disclosed herein, it is contemplated that the average particle size distribution for the large particles will typically exceed the average particle size distribution for the small particles in a given bimodal distribution. Thus, in situations where the average particle distribution size for large particles is 5 microns, for example, the average particle size distribution for small particles will be below that value. In one embodiment, the weight ratio of small to large particles may be between 25:75 and 75:25. Examples of bimodal particle distributions include those disclosed in U.S. Pat. No. 5,667,715 to Foister.

Bimodal distributions, where utilized, may be employed in a manner that provides an optimum combination of on-state yield stress and low viscosity. Monomodal particle distributions may be utilized where appropriate. Similarly, other particle distribution ratios may be employed as desired and/or required.

In one embodiment, the magnetizable particles include, for example, particles comprised of at least one of paramagnetic, superparamagnetic, or ferromagnetic compounds, or a combination thereof. The magnetizable particles may include particles comprised of at least one of iron, iron oxide, iron nitride, iron carbide, carbonyl iron, chromium dioxide, low carbon steel, silicon steel, nickel, cobalt, or the like, or a combination thereof. The iron oxide includes all forms of pure iron oxide, such as, for example, Fe₂O₃ and Fe₃O₄, as well as those containing small amounts of other elements, such as, manganese, zinc or barium. Examples of iron oxide include ferrites and magnetites.

In one embodiment, the magnetizable particles may be alloys of iron, such as, for example, those containing at least one of aluminum, silicon, cobalt, nickel, vanadium, molybdenum, chromium, tungsten, manganese, copper, or a combination thereof. Iron-cobalt alloys may have an iron-cobalt ratio ranging from about 30:70 to about 95:5, or from about 50:50 to about 85:15. The iron-nickel alloys may have an iron-nickel ratio ranging from about 90:10 to about 99:1, or from about 94:6 to 97:3.

In one embodiment, the magnetizable particles may be an iron powder. The iron powder may be any form of powdered iron, for example carbonyl iron, reduced carbonyl iron, crushed iron, milled iron, melt-sprayed iron, low carbon steel, silicon steel, potato iron, iron alloys, or mixtures thereof.

Carbonyl iron powders are gray, finely divided powders made from pure metallic iron. The carbonyl iron powders are produced by thermal decomposition of iron pentacarbonyl (Fe(CO)₅), a liquid which has been highly purified by distillation. The spherical particles include carbon, nitrogen and oxygen. These elements give the particles a core/shell structure with high mechanical hardness. Carbonyl iron materials may contain greater than 97% iron with carbon content less than about 1%, oxygen content less than 0.5% and nitrogen content less than 1%.

Examples of commercially available carbonyl iron powders that may be used include CM carbonyl iron powder and HS carbonyl iron powder, both manufactured by BASF Corporation, Florham Park, N.J. CM carbonyl iron powder includes more than 99.5 wt % iron, less than 0.05 wt % carbon, about 0.2 wt % oxygen, and less than 0.01 wt % nitrogen, with a particle size distribution of less than 10% at 4.0 μm, less than 50% at 9.0 μm, and less than 90% at 22.0 μm, with true density >7.8 g/cm³. The HS carbonyl iron powder includes minimum 97.3 wt % iron, maximum 1.0 wt % carbon, maximum 0.5 wt % oxygen, maximum 1.0 wt % nitrogen, with a particle size distribution of less than 10% at 1.5 μm, less than 50% at 2.5 μm, and less than 90% at 3.5 μm. As indicated, the weight ratio of CM to HS carbonyl powder may range from 3:1 to 1:1 but preferably is about 1:1.

The magnetizable particles can also be comprised of the specific iron-cobalt and iron-nickel alloys. The iron-cobalt alloys have an iron to cobalt ratio ranging from about 30:70 to about 95:5. In one embodiment, the iron-cobalt alloys can have an iron to cobalt ratio ranging from about 50:50 to about 85:15. The iron-nickel alloys have an iron to nickel ratio ranging from about 90:10 to about 99:1. In one embodiment, the iron-nickel alloys can have an iron to cobalt ratio ranging from about 94:6 to about 97:3. The aforementioned iron-cobalt and iron-nickel alloys may also contain a small amount of additional elements, such as, for example, vanadium, chromium, or the like, in order to improve the ductility and mechanical properties of the alloys. These additional elements are typically present in an amount that is less than about 3.0% by weight, based on the total weight of the magnetizable particles.

In still another embodiment, the magnetizable particles may be comprised of non-magnetic ceramic and polymeric fibers that include coatings of a magnetic material or a magnetic material attached thereto.

In one embodiment, the magnetizable particles may be subjected to any suitable preformulative processes to aid in enhancing performance characteristics such as magnetorheological effect, resistance to oxidation, and the like. One such non-limitative example of a suitable magnetizable particle treatment is described in U.S. Pat. No. 6,929,757, assigned to the assignee of this invention. In one embodiment, the carrier fluid is aqueous and the magnetizable particles have a hydrophobic coating. In one embodiment, the magnetizable particles have an organic phosphonate based coating as described in commonly assigned U.S. patent application Ser. No. 12/259,188, titled “Iron Powder Phosphonate Coating”, and filed Oct. 27, 2008. In one embodiment, the magnetizable particles have an octyltriethoxysilane (OTES) coating as described in commonly assigned U.S. patent application Ser. No. 11/971,298, titled “Treated Magnetizable Particles and Methods of Making and Using the Same”, and filed Jan. 9, 2008.

The amount of magnetizable particles in the MR fluid may be from about 5 to about 60 volume percent based on the total volume of the MR fluid. In another embodiment, the amount of magnetizable particles in the MR fluid composition may be about 15 to about 50 volume percent based on the total volume of the MR fluid. In yet another embodiment, the amount of magnetizable particles in the MR fluid composition may be about 20 to about 45 volume percent based on the total volume of the MR fluid. In one embodiment, the magnetizable particles may be from about 30 to about 90 weight percent based on the total weight of the MR fluid. In another embodiment, the magnetizable particles may be from about 45 to 90 weight percent based on the total weight of the MR fluid. In yet another embodiment, the magnetizable particles may be from about 60 to 90 weight percent based on the total weight of the MR fluid.

Within the MR fluid, the magnetizable particles are dispersed or suspended in a carrier fluid. The carrier fluid may be present in an amount of about 95 to about 30 volume percent based on the total volume of the MR fluid. In various embodiments, the carrier fluid may be at least one of gelatin carrier fluid, dough-like fluid carrier fluid, grease carrier fluid, PVA-water carrier fluid, PVC paste carrier fluid, silicone polymer carrier fluid, or cellulose polymer carrier fluid. The magnetizable particles in the MR fluid of various embodiments of the invention have an extremely low rate of sedimentation or settling. The magnetizable particles remain suspended under normal gravity, and when subjected to vibrations, for a long period of time. The rate of sedimentation or settling may be negligible. In one embodiment, the suspension of magnetizable particles in the MR carrier fluid may remain essentially homogeneous for an indefinite period of time when no magnetic field is applied to the MR fluid, where essentially homogenous is defined as having essentially the same composition throughout the suspension. In various embodiments, the MR fluid remains essentially homogenous for at least 5, 7, 10, 12, 15, or 20 years.

A magnetizable particle will settle in a fluid if the weight of the particle is large enough to overcome the yield stress of the fluid. The ability of the magnetizable particles to remain suspended in a fluid has been characterized by the dimensionless “gravity yield parameter,” Y_{G}, (Chhabra, R. P.) as follows, Y_{G}=T_{O}^{G}/[gR(ρ_{P}−ρ)], wₕere T^{oG} is the yield stress o^{f} the fluid, g is the acceleration of gravity, R is the radius of the magnetizable particles, ρ_{P} is the density of the magnetizable particles, and ρ is the density of the fluid. Larger values of Y_{G} indicate a better abiₗity of tₕe fluid to suspend the magnetizₐble ₚ^{a}rticle. A criti_{c}al yᵢ^{e}ld stresₛ, T_{o,crit}^{G}, can be defined _{for e}^{a}ch particulate material and radius R, and if Y_{G} is greater than Y_{G,crit}, the fluid will ₚᵣₑᵥₑₙt the magnetizable particle from settling indefinitely. Rankin, et al. (“Magnetorheology in Viscoplastic Media,” Rheo Acta, 38, 471 (1999)) indicate that for values of the critical gravity yield parameter greater than 0.1, the particles in the suspension will remain suspended indefinitely.

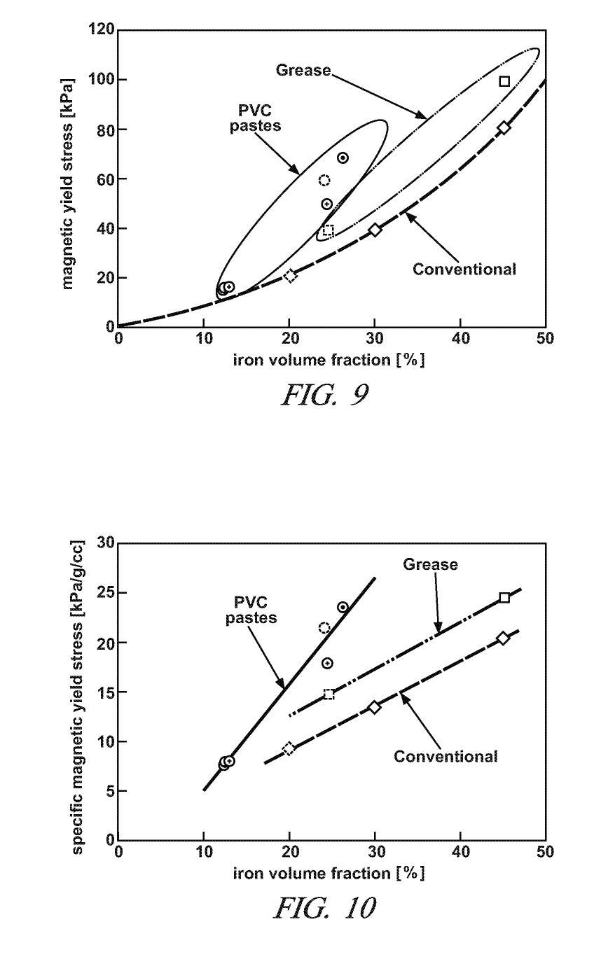

The MR fluids of various embodiments of the invention may have a higher on-state yield stress than a conventional MR fluid at the same magnetizable particle concentration. A “conventional MR fluid” is defined as an MR fluid containing low molecular weight oil(s). In one embodiment, the on-state yield stress may be as much as 150 percent higher at a given iron volume fraction, as shown in FIG. 9, for example, for the MR fluids of the invention than for a conventional MR fluid such as PAO. This higher on-state yield stress at the same magnetizable particle concentration means that a device using the MR fluids of the invention provides higher forces (e.g., torques) in the same proportion as the yield stress increase than the same size device using a conventional MR fluid. It also means that a smaller device using the MR fluid of the invention can provide the same magnitude forces as a larger device using a conventional MR fluid. While not being limited to this explanation, it is thought that the higher on-state yield stress of the MR fluids of various embodiments of the invention may be caused by the formation of “stripes,” areas of high magnetizable particle concentration, under certain conditions when MR fluids are sheared in a magnetic field. Because the magnetic yield stress is a non-linear function of the magnetizable particle concentration, a net higher yield stress can be achieved when stripes are formed.

The MR fluids of various embodiments of the invention also may have a higher off-state yield stress and viscosity than a conventional MR fluid. In one embodiment, the MR fluid may have an off-state viscosity between 0.4 and 0.6 Pascal-seconds at 40° C. In another embodiment, the MR fluid may have an off-state viscosity between about 1 and about 12 Pascal-seconds at 40° C.

In one embodiment, the carrier fluid of the MR fluid may be a gelatin carrier fluid. The gelatin carrier fluid may contain at least a polar carrier liquid and gelatin-containing, polar carrier liquid-soluble proteins. In one embodiment, the polar carrier liquid may include water. In one embodiment, the gelatin carrier fluid may include gelatin, a polar carrier liquid, untreated fumed silica, and a non-ionic surfactant. In one embodiment, the gelatin carrier fluid may include gelatin, water, and at least one of fumed silica, a non-ionic surfactant, ethylene glycol, polyethylene glycol, or poly(alpha)olefin. In one embodiment, the gelatin carrier fluid may include 10 to 20 weight percent gelatin, 70 to 80 weight percent polar carrier liquid, 0.5 to 0.7 weight percent untreated fumed silica, and 0.5 to 2 weight percent non-ionic surfactant. The gelatin may be food-grade or non food-grade. The polar carrier liquid may be, but is not limited to, water, lower alcohols such as ethanol, synthetic esters, or other hydroxyl-containing liquid.

In one example, an MR fluid comprising gelatin carrier fluid was made as follows: 6 grams of iron powder (available from BASF Corporation under the trade name HS) having an octyltriethoxysilane (OTES) coating were combined with a gelatin carrier fluid including 0.5 grams of fumed silica (Cab-o-sil M5 available from Cabot Corp. Boston, Mass.), 60 grams of water, 8 drops of non-ionic surfactant (Triton X-100 surfactant, available from Fisher Scientific, Pittsburgh, Pa.), and 12 grams of gelatin (Type A Food Grade Gelatin, 100 Bloom, Cas. No. 9000-70-8, available from MP Biomedicals, Solon, Ohio).

In one embodiment, the MR fluid comprising the gelatin carrier fluid may include 2 to 20 wt % gelatin, 15 to 55 wt % carbonyl iron, 2 to 62 wt % water, 0 to 1 wt % Triton X-100 surfactant, 0 to 1 wt % fumed silica, 2 to 40 wt % ethylene glycol, 0 to 3 wt % polyethylene glycol, and 0 to 10 wt % poly(alpha)olefin. In another embodiment, the MR fluid may include 6.3 wt % gelatin, 51.7 wt % carbonyl iron, 2.9 wt % polyethylene glycol, and 39.0 wt % ethylene glycol.

In one embodiment, the carrier fluid of the MR fluid may be a dough-like fluid. The term “dough-like fluid” as used herein is defined to mean a pliable modeling compound. The dough-like fluid generally has a relatively long shelf life and slow drying time. The dough-like carrier fluid, and the MR fluid containing the dough-like carrier fluid, may be easily extruded and deformed by modest levels of applied force. The dough-like carrier fluid may be oil-based or water-based. The composition of the dough-like carrier fluid may be varied as needed for each application.

The dough-like carrier fluid may include a starch-based binder, water or oil, and salt. The starch-based binder may include at least one of white flour, wheat flour, rye flour, rice flour, or tapioca flour. The salt may include at least one of sodium chloride, calcium chloride, or potassium chloride. In one embodiment, the dough-like carrier fluid may also include lubricant and preservative. The lubricant may include at least one of mineral spirits, mineral oil, or vegetable oil. The preservative may include at least one of calcium propionate, sodium benzoate, methyl paraben, ethyl paraben, butyl paraben, or borax.

In another embodiment, the dough-like carrier fluid many include water, a gelled poly(vinyl alcohol) resin, and filler. In another embodiment, the dough-like carrier fluid may include a polyvinyl-based binder, water, microspheres, a cross-linking agent for the polyvinyl-based binder, and a humectant, a wax, and talc. In another embodiment, the dough-like carrier fluid may include flour, water, deodorized kerosene or another petroleum distillate, salt, a drying agent such as borax, and an alum-based hardening agent.

In various embodiments, the dough-like carrier fluid may include at least one of a surfactant, humectant, hardener, wax, talc, gum, fragrance, coloring agent, or retrogradation inhibitor. The surfactant may be at least one of polyethylene glycol esters of stearic acid, polyethylene glycol esters of lauric acid, ethoxylated alcohols, polyoxyethylenesorbitan monostearate, or polyoxyethylenesorbitan monolaurate. The humectant may be at least one of glycerine, polyglycol, or polypropylene glycol. The hardener may be at least one of sodium aluminum sulfate, potassium aluminum sulfate, aluminum ammonium sulfate, aluminum sulfate, or ammonium ferric sulfate. The retrogradation inhibitor may be at least one of waxy corn starch, waxy rice starch, waxy potato starch, or amylopectin, wherein the “waxy” starches contain at least about 90% amylopectin. In one embodiment, the dough-like carrier fluid may include about 30 wt % to about 42 wt % starch-based binder; about 20 wt % to about 50 wt % water; about 5 wt % to about 15 wt % salt; about 2.0 wt % to about 4.5 wt % lubricant; about 0.2 wt % to about 1.0 wt % surfactant; about 0.1 wt % to about 1 wt % preservative; 0 wt % to about 1 wt % hardener; about 2 wt % to about 10 wt % retrogradation inhibitor; 0 wt % to about 25 wt % humectant; 0 wt % to about 0.5 wt % fragrance; and 0 wt % to about 3.5 wt % colorant. Examples of dough-like fluid compositions that may be used for the dough-like carrier fluid may be found, for example, in U.S. Pat. Nos. 6,713,624; 5,916,949; 5,171,766; 4,386,964; and 3,167,440.

In one embodiment, the MR fluid comprising the dough-like carrier fluid may include 50 to 75 wt % dough-like carrier fluid, 20 to 50 wt % carbonyl iron, 0 to 4 wt % dioctyl phthalate (DOTP), and 0 to 3 wt % Triton X-100 surfactant. In another embodiment, the MR fluid may include 50 wt % dough-like carrier fluid and 50 wt % carbonyl iron.

In one embodiment, the carrier fluid of the MR fluid may be a grease carrier fluid. The term “grease” as used herein is defined to mean a lubricating fluid that has been gelled with a thickening agent. The grease carrier fluid may have a higher initial viscosity than oil. The thickening agent may allow the grease to stay in contact with a surface to which it is applied. In one embodiment, the grease carrier fluid may include a liquid-phase lubricant and a uniformly dispersed, finely divided thickening agent.

The liquid-phase lubricant may be, for example but not limited to, poly(alpha)olefin (PAO) (a low molecular weight synthetic hydrocarbon oil), other synthetic hydrocarbons, petroleum oils, mineral oil, paraffin oil, cycloparaffin oil, vegetable oil, esters, diesters, silicones, and polyethers. The thickening agent may be a metal soap or a metal soap complex. The metal soap may be made by reacting a metal hydroxide with a fat or fatty acid. The metal hydroxide may be, for example but not limited to, a hydroxide of calcium, lithium, aluminum, sodium, or barium. The fat may be, for example but not limited to, cottonseed oil, tallow, lard, fish oil, vegetable oil, hydrogenated fats or oils, or degras. The metal soap complex may be made by reacting a metal, a fatty acid, and another acid. In one embodiment, the soap may include at least one of calcium complex soap, lithium complex soap, aluminum complex soap, sodium stearate, calcium stearate, lithium stearate, potassium stearate, zinc stearate, strontium stearate, aluminum stearate, barium stearate, magnesium stearate, or lithium-12-hydroxystearate.

In another embodiment not including soap, the thickening agent may be a treated clay, organoclay, polyurea, polytetrafluoroethylene (PTFE), organic metal salt, polyelectrolyte, polysaccharide, phospholipid, or polycarboxylate. In one embodiment, the grease carrier fluid may also include additives, for example but not limited to, graphite, carbon black, mica, talc, silica, molybdenum disulfide (MoS₂), metal oxides, fibrous material, antioxidant, or viscosity modifier.

In one embodiment, the grease carrier fluid comprises commercially available grease, for example but not limited to, AMSOIL® Synthetic Multi-Purpose Grease NLGI #2, available from AMSOIL Inc., Superior, Wis. The MR fluid containing grease carrier fluid may stay in the active gap area (the region in the MR device in which the MR fluid is exposed, by design, to the magnetic field) when sheared as opposed to conventional MR fluids which may be flung out of the active gap area when sheared.

In one embodiment, the MR fluid comprising the grease carrier fluid may include 55 to 75 wt % grease and 25 to 45 wt % carbonyl iron. In one embodiment, the MR fluid includes 12 wt % grease and 88 wt % carbonyl iron.

In various examples, MR fluid was made consisting of iron particles and grease carrier fluid consisting of AMSOIL® Synthetic Multi-Purpose Grease NLGI #2. FIG. 1 shows the on-state yield stress (also called the magnetic yield stress) versus flux density for the MR fluids made in these examples compared to conventional PAO-based MR fluids. Referring to FIG. 1, the data points represented by a filled square and by a filled circle are for MR fluid consisting of AMSOIL® Synthetic Multi-Purpose Grease NLGI #2 and 45 volume percent iron. The data points represented by an open circle are for an MR fluid consisting of the grease and 25 volume percent iron. The data points represented by an open square are for a conventional MR fluid consisting of the PAO-based fluid SHF21 (manufactured by Mobil Chemical Company) and 30 volume percent iron. The data points represented by a filled triangle, by “X”, and by “+” are for a conventional MR fluid consisting of the PAO-based fluid SHF21 and 45 volume percent iron.

As seen in FIG. 1, the MR fluid made with grease carrier fluid and 25 volume percent iron had about the same, or higher, on-state yield stress across nearly the entire range of flux density as a conventional MR fluid with 30 volume percent iron. In addition, the MR fluid made with grease carrier fluid and 45 volume percent iron provided an on-state yield stress on the order of 20 percent higher at magnetic saturation (flux density around 1 tesla and above) than conventional MR fluids at the same iron concentration.

In another embodiment, the carrier fluid of the MR fluid may be a PVA-water carrier fluid. The term “PVA-water” or “PVA-water fluid” as used herein is defined to mean a viscous cross-linked polymer. The PVA-water carrier fluid is a viscoelastic fluid. In one embodiment, the PVA-water carrier fluid includes a polymeric material, a cross-linking (gelling) agent, and water. The ratio of polymeric material to cross-linking agent may impact the consistency of the PVA-water fluid. In one embodiment, the weight ratio of cross-linking agent relative to polymeric material may be about 1:1 to 1:10. In one embodiment, the PVA-water carrier fluid includes polyvinyl alcohol (PVA), borax (sodium borate), and water. Although PVA is the most common polymeric material included in PVA-water fluid, any suitable polymeric material may be used, for example but not limited to polyvinylacetate (PVAC) or polyvinyl pyrrolidone. The cross-linking agent may be, for example but not limited to borax, boric acid, zinc borate, sodium tetraborate-decahydrate, or a zirconium salt. In other embodiments, the PVA-water carrier fluid may include at least one of a polysaccharide gum such as guar gum, xantham gum, or gelatin; methylcellulose; cornstarch; fortified milk; fillers; preservatives such as formaldehyde or methylparaben; colorants; fragrances; or various acids or bases.

The MR fluid containing the PVA-water carrier fluid may have a relatively high viscosity at low shear rates but a very low viscosity at high shear rates. The high viscosity of the MR fluid containing the PVA-water carrier fluid at low shear rates may be recovered after the material is sheared at high rates. The MR fluid containing the PVA-water carrier fluid is also highly shear thinning at low shear rates, for example at less than 100 s⁻¹. The high viscosity at low shear will prevent the magnetic particles in the MR fluid containing the PVA-water carrier fluid from settling, while the low viscosity at high shear will allow the MR fluid containing the PVA-water carrier fluid to behave conventionally as an MR fluid.

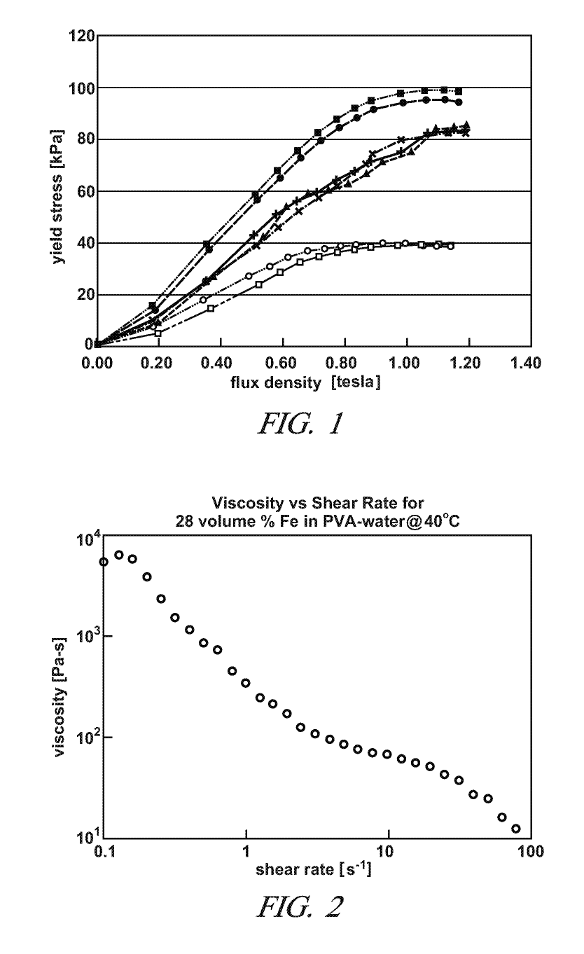

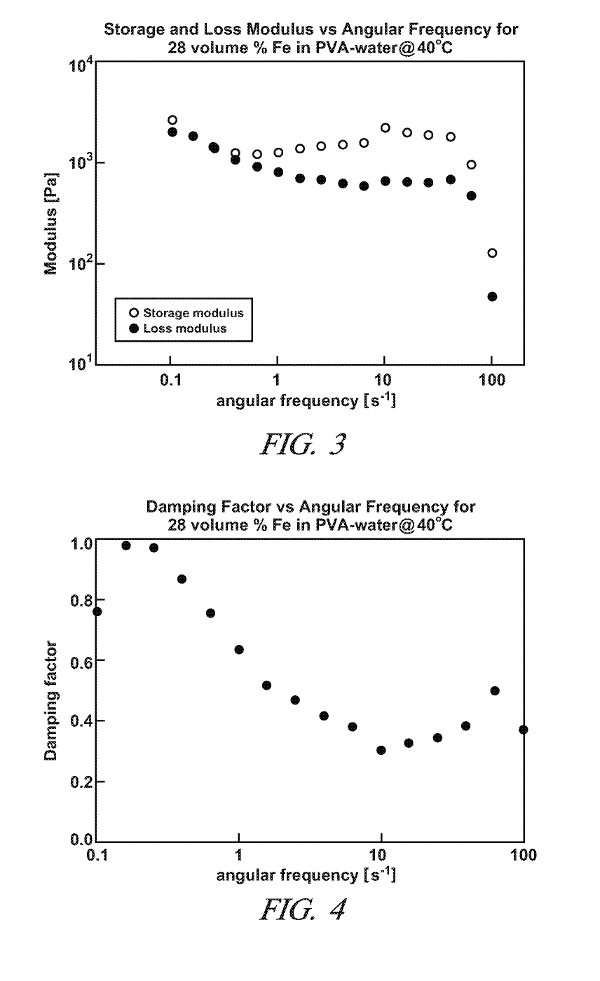

In one example, an MR fluid was made comprising the PVA-water carrier fluid and 28% by volume of iron particles. FIG. 2 shows the results of a viscosity test at 40° C. for this MR fluid. FIG. 2 indicates that this MR fluid is strongly shear thinning. This means that the unsheared material has a very high viscosity and the iron particle settling will be very slow to negligible. On the other hand, when the material is sheared, the viscosity decreases by almost three orders of magnitude and it can flow relatively easily. This is ideal behavior for an MR fluid that will be sheared only occasionally. FIG. 3 shows the storage modulus and loss modulus versus angular frequency as measured at 40° C. for this MR fluid. FIG. 4 shows the damping factor (the ratio of loss modulus to storage modulus) versus angular frequency as measured at 40° C. for this MR fluid.

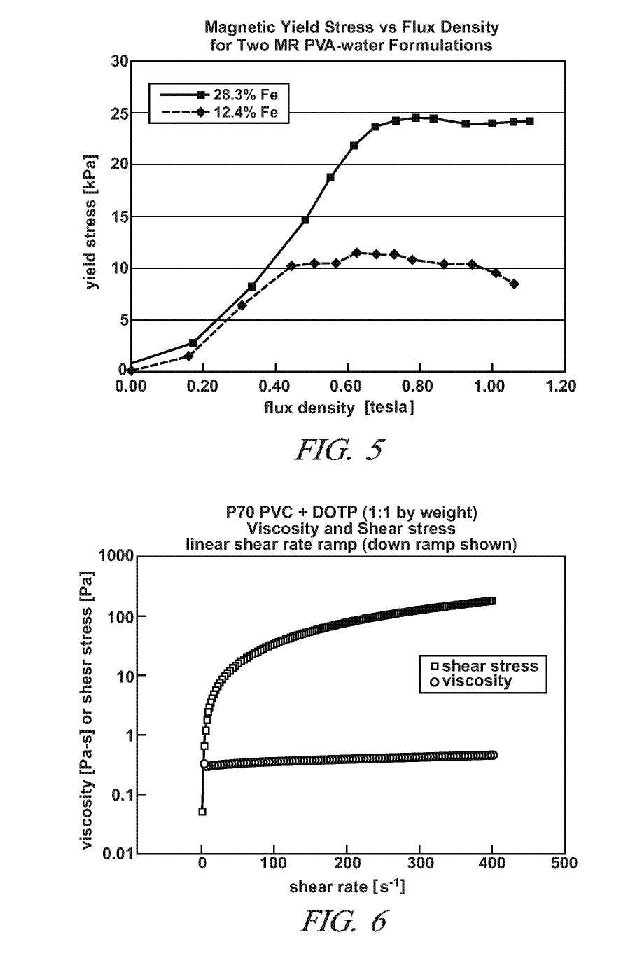

In another example, one MR fluid was made comprising the PVA-water carrier fluid and 28.3% by volume of iron particles, and a second MR fluid was made comprising the PVA-water carrier fluid and 12.4% by volume of iron particles. FIG. 5 shows the on-state yield stress versus flux density for these two MR fluids. FIG. 5 demonstrates that these MR fluids made with PVA-water fluid behave as typical MR fluids in the on-state.

In one embodiment, the MR fluid comprising the PVA-water carrier fluid may include 20 to 50 wt % PVA-water carrier fluid and 50 to 80 wt % carbonyl iron. In another embodiment, the MR fluid may include 50 wt % PVA-water carrier fluid and 50 wt % carbonyl iron.

In one embodiment, the carrier fluid of the MR fluid may be a PVC paste carrier fluid. The PVC paste carrier fluid may include at least one plasticizer, for example but not limited to dioctyl phthalate (DOTP) or phthalates of other compositions. A plasticizer may be added to a polymer such as PVC to increase the pliability of the polymer. AN MR fluid containing PVC and DOTP may be useable at higher temperatures than conventional MR fluids due to the high boiling point of DOTP. In one embodiment, the PVC paste carrier fluid may also include additives.

In one embodiment, the MR fluid comprising the PVC paste carrier fluid may include 20 to 70 wt % PVC, 8 to 50 wt % carbonyl iron, 15 to 40 wt % DOTP, and 0 to 1 wt % fumed silica. In one embodiment, the MR fluid may include 72.7% PVC, 9.1 wt % carbonyl iron, and 18.2 wt % DOTP.

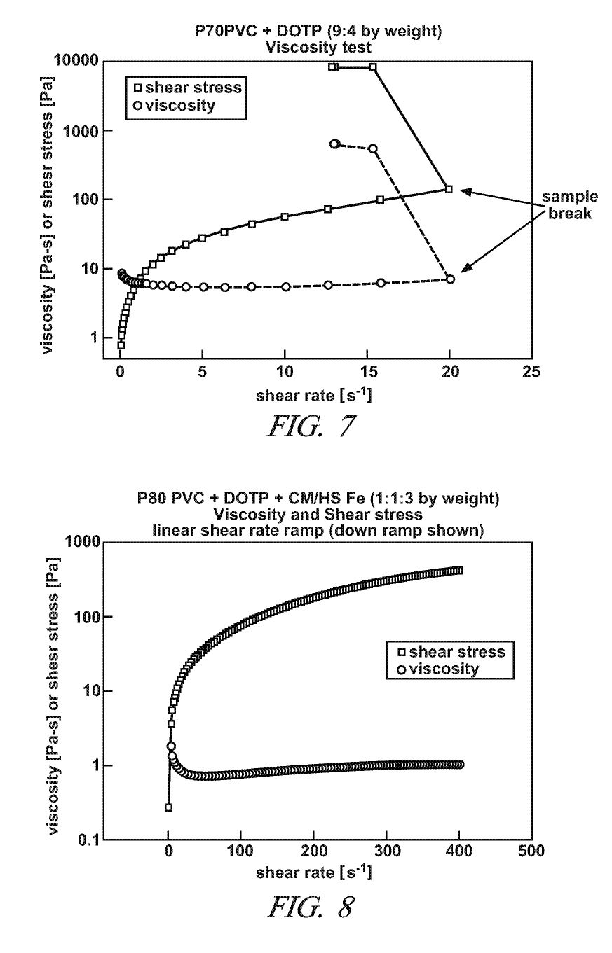

The viscous properties of the PVC paste carrier fluid can be varied significantly by varying the ratio of the components. Higher concentrations of PVC may produce a PVC paste carrier fluid that is shear thickening (viscosity increases as rate of shear increases) at relatively low shear rates, while higher concentrations of a plasticizer may produce a PVC paste carrier fluid that is shear thinning (viscosity decreases as rate of shear increases) at relatively low shear rates. A PVC paste carrier fluid including PVC and DOTP may provide the MR fluid containing the PVC paste carrier fluid with a high off-state viscosity that is shear thinning at low shear rates, and a higher on-state yield stress compared to conventional MR fluids at the same magnetic particle concentration. In one example, a PVC paste carrier fluid was made consisting of a 1:1 ratio by weight of PVC:DOTP, where the PVC polymer used was Vinnolit P 70, available from Vinnolit GmbH & Co. KG, Munich, Germany. Vinnolit P 70 is a fine-particle, paste-making micro-suspension homopolymer. The 1:1 ratio provided a shear thinning mixture at very low shear rates and a nearly Newtonian fluid at higher shear rates. FIG. 6 shows the results of a viscosity test of this 1:1 PVC paste carrier fluid. In another example, a PVC paste carrier fluid was made consisting of a 9:4 ratio by weight of PVC(Vinnolit P 70):DOTP. FIG. 7 shows the results of a viscosity test of this 9:4 PVC paste carrier fluid. FIG. 6 demonstrates that at a relatively low PVC:DOTP weight ratio the viscosity is relatively constant with shear rate and shows a relatively small amount of dilatant behavior (viscosity increases slightly with shear rate). On the other hand, FIG. 7 demonstrates that at a relatively high PVC:DOTP weight ratio, the material shows a dramatic increase in viscosity and strong dilatant behavior at relatively low shear rates. These results demonstrate that a wide range of fluid behavior is attainable with readily obtainable changes in fluid composition.

In another example, an MR fluid was made consisting of a 1:1:3 ratio by weight of PVC:DOTP:carbonyl iron particles. The PVC polymer used was Vinnolit P 80, available from Vinnolit GmbH & Co. KG, Munich, Germany. Vinnolit P 80 is a fine-particle, paste-making micro-suspension homopolymer. This 1:1:3 MR fluid had a rheology similar to a PVC and DOTP mixture with no carbonyl iron added. In addition, an MR fluid containing PVC, DOTP, and carbonyl iron was shown to exhibit significantly higher magnetic yield stresses compared to conventional MR fluids in a similar range of iron concentrations. In another example, an MR fluid was made consisting of a 1:1:3 ratio by weight of PVC(Vinnolit P 80):DOTP:CM/HS iron (available from BASF Corporation), and the results of a viscosity test of this 1:1:3 ratio PVC paste carrier fluid are shown in FIG. 8. FIG. 8 demonstrates that PVC:DOTP:iron mixtures can be produced with similar viscosities to that of the PVC:DOTP alone.

FIG. 9 shows the on-state yield stress at 40° C. and 1 tesla at various volume fractions of iron for an MR fluid containing PVC, DOTP, and iron particles, and MR grease fluid, and a conventional MR fluid. As seen in FIG. 9, the on-state yield stress of the MR fluids of the invention may be ten to twenty percent higher than those of conventional MR fluids having the same iron volume fraction.

FIG. 10 shows the specific on-state yield stress (the on-state yield stress as shown in FIG. 9 divided by the fluid density) at 40° C. and 1 tesla at various volume fractions of iron for an MR fluid containing PVC, DOTP, and iron particles, and MR grease fluid, and a conventional MR fluid. The higher specific on-state yield stress at the same iron volume fraction for the MR fluids of the invention compared to the conventional MR fluid indicates that either the yield stress is higher or the fluid density is lower, or both, for the MR fluids of the invention.

In one embodiment, the carrier fluid of the MR fluid may be silicone polymer carrier fluid. The silicone polymer carrier fluid may include a silicone polymer, for example but not limited to dimethyl silicone polymer. In another embodiment, the silicone polymer carrier fluid may include silicone oil and a boron compound such as boric acid. The silicone polymer carrier fluid may include other additives, for example at least one of silica, polydimethylsiloxane, decamethyl cyclopentasiloxane, glycerine, titanium dioxide, or modified derivatives of castor oil. The silicone polymer carrier fluid is viscoelastic. In one embodiment, the MR fluid may include 30 to 60 wt % silicone polymer carrier fluid and 40 to 70 wt % carbonyl iron. In another embodiment, the MR fluid may include 39.1% silicone polymer carrier fluid and 60.9 wt % carbonyl iron.

In one embodiment, the carrier fluid of the MR fluid may be cellulose polymer carrier fluid. The cellulose polymer carrier fluid may include hydroxyethylcellulose, poly(alpha)olefin, and ethylene glycol. In one embodiment, the MR fluid may include 1 to 5 wt % c hydroxyethylcellulose, 0 to 15 wt % poly(alpha)olefin, 0 to 50 wt % ethylene glycol, and 30 to 50 wt % carbonyl iron. In another embodiment, the MR fluid may include 4.4 wt % hydroxyethylcellulose, 12.5 wt % poly(alpha)olefin, 49.8 wt % ethylene glycol and 33.3 wt % carbonyl iron.

A method of manufacturing the MR fluid includes mixing the magnetizable particles and the carrier fluid in a suitable mixing device to form a suitable mixture. If desired, mixing may be conducted at an elevated temperature of greater than or equal to about 50° C. The mixing can take place in a device that uses shear force, extensional force, compressive force, ultrasonic energy, electromagnetic energy, thermal energy or combinations comprising at least one of the foregoing forces and energies and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, screen packs, rolls, rams, helical rotors, or combinations comprising at least one of the foregoing. Exemplary mixing devices are extruders such as single screw and twin screw extruders, buss kneaders, helicones, Eirich mixers, Waring blenders, Henschel mixers, or the like.

The MR fluid can be used in devices such as, but not limited to, dampers, energy impact absorbers, crash boxes, knee bolsters, sliding seats, mounts, clutches, brakes, valves, alternators, power steering pumps, mounts, artificial joints, toys, and sporting equipment. These devices may include a housing or chamber that contains the MR fluid. A magnetic flux density ranging from about 0.01 Tesla to about 2 Tesla, for example, may be applied to the MR fluids to increase the viscosity thereof when used in such devices. These devices may be controllable or tunable by means of varying the intensity of the applied magnetic field.

Because the magnetizable particles in the MR fluid have an extremely low settling rate, the MR fluid is particularly suitable for use in MR fluid applications requiring long particle settling times. For example, a damper used in a crash impact absorber in a vehicle may remain unused until it is suddenly needed on demand during a crash years after the vehicle was manufactured. The crash damper must be able to respond to a crash event for a period, for example, of up to ten years after the device is placed in the vehicle. This crash damper will also likely be exposed to vibrations and accelerations common to normal vehicle operation. The magnetic particles must remain suspended in order for the crash damper to respond to an applied magnetic field in a predictable manner. The MR fluid of various embodiments of the invention is also particularly suitable for use in MR fluid applications that are prone to high particle settling rates, for example MR clutches which produce high centrifugal force.

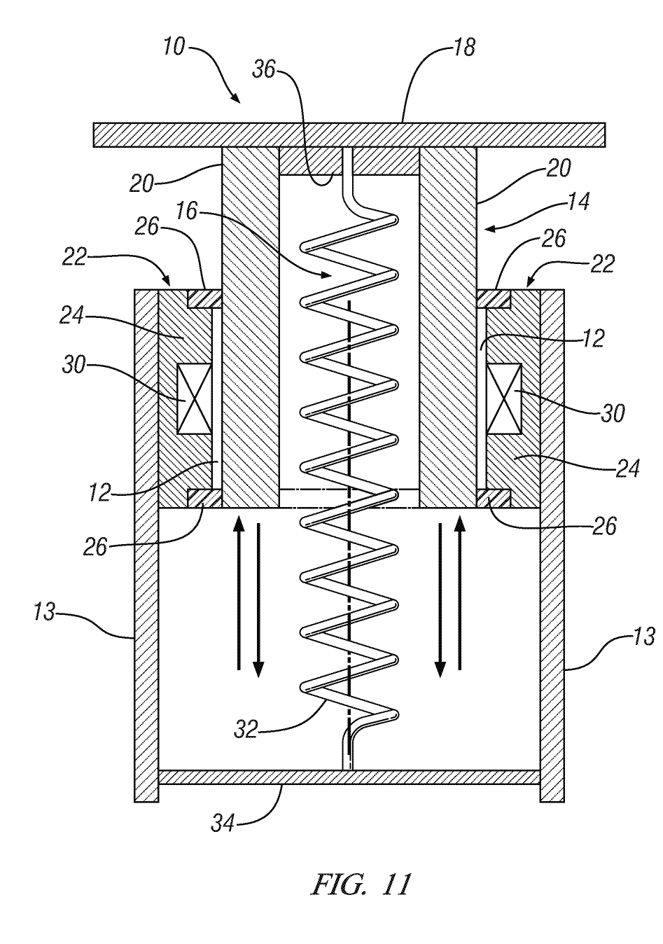

In one embodiment, an MR fluid of one embodiment of the invention may be used in such a crash damper. The crash damper may be a tunable, extruder-type crash damper having a variable magnetic field generator to control the apparent viscosity of the MR fluid as it flows through the extruder orifice. Such control of the apparent viscosity of the MR fluid may allow tuning of the stroke of the damper with time, thus controlling the impact forces on various parts of the vehicle to which the damper is attached, for example but not limited to the seats, knee bolsters, and bumpers. FIG. 11 shows one embodiment of a tunable energy impact absorber (or crash damper) 10 utilizing an MR fluid 12 according to one embodiment.

Referring to FIG. 11, the impact energy absorber 10 includes a pair of stationary framing members 13, a first impact energy-absorbing assembly 14, and an optional second impact energy absorbing assembly 16. Stationary framing members 13 can be rails of a vehicle chassis such as may be desirable for providing a tunable impact energy absorber assembly for a front or rear vehicle bumper system, or can be attached to a stationary object as part of an energy absorber system for the object, or the like. The framing members 13 are not intended to be limited to any particular application and are suitable for use in any application desiring a tunable and reusable impact energy control.

The first impact energy absorbing assembly 14 comprises a movable impact surface 18 supported by support member 20, wherein an MR fluid 10 according to one embodiment of the invention controls movement. The MR fluid 10 includes magnetizable particles dispersed or suspended in a carrier fluid, where the carrier fluid may be at least one of gelatin carrier fluid, dough-like carrier fluid, grease carrier fluid, PVA-water carrier fluid, or PVC paste carrier fluid, as described above.

Although the cross sectional view in FIG. 11 illustrates two support members 20, the support member 20 is preferably cylindrical shaped and formed of a unitary member. Support member 20 is preferably formed from a soft magnetic material, defined as those materials that exhibit magnetic properties only when they are subject to a magnetizing force such as a magnetic field created when a current is passed through a wire surrounding a soft magnetic core.

The first impact energy surface structure 14 absorbs energy by slidably engaging framing members 13 during an impact event via control structure 22 fixedly attached to the framing members 13. The control structure 22 comprises a cylindrical sleeve 24 having an annular opening dimensioned to accommodate an outer diameter of the support members 20 of the first impact energy surface structure 14. The cylindrical sleeve 24 is fixedly attached to the frame members 13. Annular seals 26 are disposed at each end of the control structure 22 and abut an outer diameter of support member 20. The annular seals 26 enclose the MR fluid 12 that the support member 20 is slidably engaged therewith. Seals 26 also function as bearings during operation of the impact energy absorber 10. A coil 30 is centrally disposed within the cylindrical sleeve 24 in close proximity to the MR fluid 12.

The second impact energy absorbing assembly 16 includes a spring 32 fixedly attached at one end to transverse member 34, wherein the transverse member 34 is fixedly attached at each end to framing members 13. At the other end of the spring 32, there is a secondary impact surface 36, which is preferably a disk dimensioned to fit within a cylindrically shaped recess defined by support member 20. Upon an impact event, the secondary impact surface 36 is displaced as the spring 32 is compressed as a result of the impact event. Relaxation of spring 32 returns the secondary impact surface to its original position. Also, depending on whether a magnetic field is applied to the MR fluid 12 via coil 30, relaxation of the spring 32 will cause the first impact surface 18 to return to its original position.

In another embodiment, an MR fluid of one embodiment of the invention may be used in a clutch assembly to control the fluid coupling between two rotating members. The change in yield stress from the MR fluid is relatively rapid, e.g., on the order of milliseconds, and is reversible. Since the magnetic field can be rapidly controlled by the application of current to the field coil, the yield stress of the MR fluid and thus the clutch torque can be changed just as rapidly.

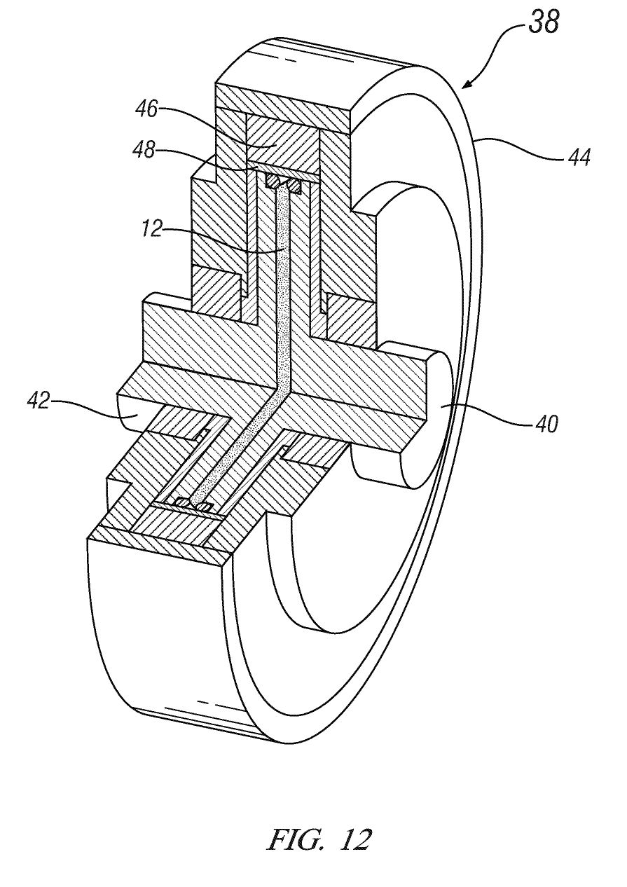

FIG. 12 shows a clutch mechanism 38 utilizing the MR fluid 12 of one embodiment of the invention. The clutch mechanism 38 includes a first rotating member 40 and a second rotating member 42. The first rotating member 40 may be an input shaft and plate. The second rotating member 42 may be an output shaft and plate. The MR fluid 12 of one embodiment of the invention may be operatively disposed between the first 40 and second 42 rotating members. The MR fluid 12 includes magnetizable particles dispersed or suspended in a carrier fluid, where the carrier fluid may be at least one of gelatin carrier fluid, dough-like carrier fluid, grease carrier fluid, PVA-water carrier fluid, or PVC paste carrier fluid, as described above.

The clutch mechanism 38 may further comprise, among other components known to the skilled artisan, a casing 44; an electromagnetic coil 46; and an electromagnetic core 48 operatively disposed within clutch mechanism 38. When the MR fluid 10 is exposed to a magnetic field, the yield stress of the MR fluid 10 increases by several orders of magnitude. This increase in yield stress may be used to control the fluid coupling between the two rotating members 40, 42 in the clutch.

The above description of embodiments of the invention is merely exemplary in nature and, thus, variations thereof are not to be regarded as a departure from the spirit and scope of the invention.

What is claimed is:

1. A product comprising:
a magnetorheological fluid having an on-state yield stress when a magnetic field is applied thereto and comprising:
a carrier fluid;
magnetizable particles suspended in the carrier fluid;
wherein the suspension of the magnetizable particles in the carrier fluid remains essentially homogenous indefinitely in the absence of the magnetic field;
wherein the on-state yield stress of the magnetorheological fluid is greater than or equal to that of poly(alpha)olefin fluid containing the same concentration of magnetizable particles; and
wherein the off-state viscosity of the magnetorheological fluid is between about 0.4 and about 12 Pascal-seconds at 40° C.

2. A product as set forth in claim 1 wherein the on-state yield stress of the magnetorheological fluid is about ten percent to about twenty percent greater than that of poly(alpha)olefin fluid containing the same concentration of magnetizable particles.

3. A product as set forth in claim 1 wherein the magnetizable particles have an average particle size of about 0.01 micrometer to about 500 micrometers.

4. A product as set forth in claim 1 wherein the magnetizable particles have an average particle size of about 0.01 micrometer to about 50 micrometers.

5. A product as set forth in claim 1 wherein the magnetizable particles comprise a bimodal distribution of small particles and large particles, wherein the small particles have an average particle size between about 0.5 and 10 micrometers and the large particles have an average particle size between about 5 and about 30 micrometers, and wherein the weight ratio of small to large particles is between 25:75 and 75:25.

6. A product as set forth in claim 1 wherein the magnetizable particles comprise at least one of iron, iron oxide, iron nitride, iron carbide, carbonyl iron, chromium dioxide, low carbon steel, silicon steel, nickel, cobalt, iron oxides that contain small amounts of manganese, zinc or barium; alloys of iron that contain at least one of aluminum, silicon, cobalt, nickel, vanadium, molybdenum, chromium, tungsten, manganese, or copper; iron-cobalt alloys having an iron to cobalt ratio ranging from about 30:70 to about 95:5; iron-nickel alloys having an iron to nickel ratio ranging from about 90:10 to about 99:1; or a combination thereof.

7. A product as set forth in claim 1 wherein the magnetizable particles make up 5 to 60 volume percent of the magnetorheological fluid.

8. A product as set forth in claim 1 wherein the magnetizable particles make up 30 to 90 weight percent of the magnetorheological fluid.

9. A product as set forth in claim 1 wherein the magnetizable particles comprise a hydrophobic coating.

10. A product as set forth in claim 1 wherein the magnetizable particles comprise an octyltriethoxysilane coating.

11. A product as set forth in claim 1 wherein the magnetizable particles comprise an organic phosphonate based coating.

12. A product as set forth in claim 1 wherein the carrier fluid comprises gelatin and a polar carrier liquid.

13. A product as set forth in claim 12 wherein the carrier fluid further comprises at least one of fumed silica, a non-ionic surfactant, ethylene glycol, polyethylene glycol, or poly(alpha)olefin.

14. A product as set forth in claim 12 wherein the polar carrier liquid is water.

15. A product as set forth in claim 12 wherein the magnetorheological fluid comprises 2 to 20 wt % gelatin, 2 to 62 wt % water, 0 to 1 wt % non-ionic surfactant, 0 to 1 wt % fumed silica, 2 to 40 wt % ethylene glycol, 0 to 3 wt % polyethylene glycol, 0 to 10 wt % poly(alpha)olefin, and 15 to 55 wt % carbonyl iron.

16. A product as set forth in claim 1 wherein the carrier fluid comprises a dough-like carrier fluid comprising a starch-based binder, water or oil, and salt.

17. A product as set forth in claim 15 wherein the starch-based binder includes at least one of white flour, wheat flour, rye flour, rice flour, or tapioca flour.

18. A product as set forth in claim 15 wherein the salt comprises at least one of sodium chloride, calcium chloride, or potassium chloride.

19. A product as set forth in claim 15 wherein the carrier fluid further comprises a lubricant comprising at least one of mineral spirits, mineral oil, or vegetable oil.

20. A product as set forth in claim 15 wherein the carrier fluid further comprises at least one of a surfactant, humectant, hardener, wax, talc, gum, fragrance, coloring agent, drying agent, alum-based hardening agent, preservative, or retrogradation inhibitor

21. A product as set forth in claim 15 wherein the magnetorheological fluid comprises 50 to 75 wt % dough-like carrier fluid, 20 to 50 wt % carbonyl iron, 0 to 4 wt % dioctyl phthalate, and 0 to 3 wt % surfactant.

22. A product as set forth in claim 1 wherein the carrier fluid comprises a grease comprising a lubricating fluid and a thickening agent.

23. A product as set forth in claim 22 wherein the lubricating fluid comprises at least one of poly(alpha)olefin, other synthetic hydrocarbons, petroleum oils, mineral oil, paraffin oil, cycloparaffin oil, vegetable oil, esters, diesters, silicones, or polyethers.

24. A product as set forth in claim 22 wherein the thickening agent comprises at least one of a metal soap, metal soap complex, treated clay, organoclay, polyurea, polytetrafluoroethylene (PTFE), organic metal salt, polyelectrolyte, polysaccharide, phospholipid, or polycarboxylate.

25. A product as set forth in claim 22 wherein the carrier further comprises at least one of graphite, carbon black, mica, talc, silica, molybdenum disulfide (MoS₂), metal oxides, fibrous material, antioxidant, or viscosity modifier.

26. A product as set forth in claim 22 wherein the magnetorheological fluid comprises 55 to 75 wt % grease and 25 to 45 wt % carbonyl iron.

27. A product as set forth in claim 1 wherein the carrier fluid comprises a polymeric material, a cross-linking agent, and water.

28. A product as set forth in claim 27 wherein the polymeric material is polyvinyl alcohol.

29. A product as set forth in claim 27 wherein the cross-linking agent is at least one of borax, boric acid, zinc borate, sodium tetraborate-decahydrate, or a zirconium salt.

30. A product as set forth in claim 27 wherein the carrier fluid further comprises at least one of a polysaccharide gum such as guar gum, xantham gum, or gelatin; methylcellulose; cornstarch; fortified milk; fillers; preservatives such as formaldehyde or methylparaben; colorants; fragrances; or various acids or bases.

31. A product as set forth in claim 28 wherein the magnetorheological fluid comprises 20 to 50 wt % of polyvinyl alcohol, cross-linking agent, and water; and 50 to 80 wt % carbonyl iron.

32. A product as set forth in claim 1 wherein the carrier fluid comprises poly-vinyl chloride and at least one plasticizer.

33. A product as set forth in claim 32 wherein the plasticizer is dioctyl phthalate.

34. A product as set forth in claim 32 wherein the magnetorheological fluid comprises 20 to 70 wt % poly-vinyl chloride, 15 to 40 wt % dioctyl phthalate, 0 to 50 wt % ethylene glycol, and 30 to 50 wt % carbonyl iron.

35. A product as set forth in claim 1 wherein the carrier fluid comprises silicone polymer.

36. A product as set forth in claim 35 wherein the carrier fluid further comprises at least one of silica, polydimethylsiloxane, decamethyl cyclopentasiloxane, glycerine, titanium dioxide, or modified derivatives of castor oil.

37. A product as set forth in claim 35 wherein the magnetorheological fluid comprises 30 to 60 wt % carrier fluid comprising silicone polymer, and 40 to 70 wt % carbonyl iron.

38. A product as set forth in claim 1 wherein the carrier fluid comprises a cellulose polymer.

39. A product as set forth in claim 38 wherein the carrier fluid comprises hydroxyethylcellulose, poly(alpha)olefin, and ethylene glycol.

40. A product as set forth in claim 38 wherein the magnetorheological fluid comprises 1 to 5 wt % hydroxyethylcellulose, 0 to 15 wt % poly(alpha)olefin, 0 to 50 wt % ethylene glycol, and 30 to 50 wt % carbonyl iron.

41. A product comprising:
a tunable device comprising at least one chamber comprising magnetorheological fluid having an on-state yield stress when a magnetic field is applied thereto and wherein the magnetorheological fluid comprises:
a carrier fluid;
magnetizable particles suspended in the carrier fluid;
wherein the suspension of the magnetizable particles in the carrier fluid remains essentially homogenous indefinitely in the absence of the magnetic field;
wherein the on-state yield stress of the magnetorheological fluid is greater than or equal to that of poly(alpha)olefin fluid containing the same concentration of magnetizable particles; and
wherein the off-state viscosity of the magnetorheological fluid is between about 0.4 and about 12 Pascal-seconds at 40° C.

42. A product as set forth in claim 41 wherein the tunable device comprises a damper, energy impact absorber, crash box, knee bolster, sliding seat, mount, clutch, brake, valve, alternator, power steering pump, mount, artificial joint, toy, or sporting equipment.

43. A product as set forth in claim 41 wherein the on-state yield stress of the magnetorheological fluid is about ten percent to about twenty percent higher than that of poly(alpha)olefin fluid containing the same concentration of magnetizable particles.

44. A method comprising:
applying a magnetic field to magnetorheological fluid to increase the yield-stress of the magnetorheological fluid such that its on-state yield stress is greater than or equal to that of poly(alpha)olefin fluid containing the same concentration of magnetizable particles, wherein the magnetorheological fluid comprises:
a carrier fluid;
magnetizable particles suspended in the carrier fluid;
wherein the suspension of the magnetizable particles in the carrier fluid remains essentially homogenous indefinitely in the absence of the magnetic field; and
wherein the off-state viscosity of the magnetorheological fluid is between about 0.4 and about 12 Pascal-seconds at 40° C.

45. A method as set forth in claim 44 wherein the on-state yield stress of the magnetorheological fluid is from about ten percent to about twenty percent higher than that of poly(alpha)olefin fluid containing the same concentration of magnetizable particles.
